(19) United States
(12) Patent Application Publication
(10) Pub. No.: US 2026/0321483 A1
(43) Pub. Date: Oct. 15, 2026

(54) Coil Component And Method Of Manufacturing Coil Component

(71) Applicant: SUMIDA CORPORATION, Tokyo (JP)

(72) Inventor: Asami MURAKAMI, Natori City (JP)

(21) Appl. No.: 19/691,220

(22) Filed: May 28, 2026

Related U.S. Application Data
(63) Continuation of application No. PCT/JP2023/043775, filed on Dec. 7, 2023.

(51) Int. Cl. H01F 27/29; H01F 27/06; H01F 27/24; H01F 41/02; H01F 41/04

(52) U.S. Cl. CPC H01F 27/29; H01F 27/06; H01F 27/24; H01F 41/0206; H01F 41/04

(57) ABSTRACT

A coil component includes a base unit that holds coils and cores and has a terminal member arranged thereon. The base unit includes a pedestal portion and a standing portion. A terminal member is arranged at the pedestal portion. The coils or the cores are placed on the pedestal portion. The standing portion is arranged standing in a standing direction to intersect a surface of the pedestal portion. In addition, the base unit is formed by integrating the pedestal portion and the standing portion. One end surface of each of the plurality of coils faces a facing surface which is a side surface of the standing portion.

### CROSS REFERENCE TO RELATED APPLICATIONS

This application claims priority to International Patent Application No. PCT/JP2023/043775, filed on Dec. 7, 2023, which is expressly incorporated herein by reference in its entirety.

### BACKGROUND

### Technical Field

The present invention relates to a coil component and a method of manufacturing a coil component.

### Related Art

Some coil components are manufactured by arranging a plurality of coils and a plurality of cores on a base unit made of a resin or the like. In connection with a technique of this type, Japanese Patent Laid-Open No. 2020-174112 (PATENT DOCUMENT 1) discloses a coil component (a composite component (100)) formed by arranging E-type cores (20A, 20B) and coils (30A, 30B) on a resin base (10). Specifically, a first coil (30A) is arranged so as to be fitted into a metal terminal (14A). The metal terminal (14A) includes a bottom surface portion (14A1), and a side surface portion (14A2) and a pressing portion (14A3) that stand from the bottom surface portion (14A1). A second coil (30B) is also arranged to be fitted into a metal terminal (14C).

When the coil (30A, 30B) is arranged on the resin base (10) in PATENT DOCUMENT 1, it is necessary to arrange the coil (30A, 30B) at a predetermined position on the resin base (10) so that the coil (30A, 30B) is fitted into the metal terminal (14A, 14C). The necessity to arrange the coil (30A, 30B) at the desired position in this manner may cause difficulty in manufacturing a coil component. For example, this technique requires a step of adjusting a position of the coil (30A, 30B) relative to the resin base (10) before arranging the coil (30A, 30B) on the resin base (10), causing an increase in workload for manufacturing the coil component.

The present invention has been made in view of the problem described above and provides a coil component easy to be manufactured.

### SUMMARY

A coil component of the present invention includes a plurality of (two or more) cores, a plurality of (two or more) coils that are spirally arranged around at least respective parts of the plurality of cores, and a base unit that holds the coils and the cores and has a terminal member arranged thereon, in which the base unit includes a pedestal portion on which the terminal member is arranged and the coils or the cores are placed, and a standing portion that is arranged standing in a standing direction in a standing direction in a standing direction in a standing direction in a standing direction in a standing direction in a standing direction in a standing direction in a standing direction in a standing direction in a standing direction in a standing direction to intersect a surface of the pedestal portion, in which the pedestal portion and the standing portion are integrally formed, and one end surface of each of the plurality of coils faces a facing surface which is a side surface of the standing portion.

A method of manufacturing a coil component of the present invention is a method of manufacturing a coil component that includes a plurality of (two or more) cores, a plurality of (two or more) coils that are spirally arranged around at least respective parts of the cores, and a base unit that holds the coils and the cores and has a terminal member arranged thereon, in which the base unit includes a pedestal portion on which the terminal member is arranged and the coils or the cores are placed, and a standing portion that is arranged standing in a standing direction to intersect a surface of the pedestal portion, in which the pedestal portion and the standing portion are integrally formed, the method including attaching the coil to the base unit by moving the coil toward a facing surface which is a side surface of the standing portion in such a direction that one end surface of the coil faces the facing surface.

When the coil component of the present invention is manufactured, the coil is arranged on the base unit in such a direction that an end surface of the coil faces the side surface of the standing portion. In this case, the coil is moved in the axial direction of the coil to be arranged on the base unit, and the standing portion provided in the base unit reduces an accidental movement of the coil beyond the side surface of the standing portion. That is, the position adjustment of the coil is assisted by the standing portion. In other words, it is possible to reduce steps required to adjust the position of the coil relative to the base unit before arranging the coil in the base unit. Since the standing portion and the pedestal portion are integrally formed, the need to adjust the position of the standing portion in the pedestal portion is eliminated.

### Effect of the Invention

According to a coil component of the present invention, it is possible to easily adjust a position of a coil relative to a base unit by arranging the coil so that an end surface of the coil is fitted to a side surface of a standing portion. Integrally forming the standing portion and a pedestal portion eliminates the step of performing position adjustment between the standing portion and the pedestal portion to attach the standing portion to the pedestal portion. This can provide the coil component easy to be manufactured.

### BRIEF DESCRIPTION OF THE DRAWINGS

The object described above, other objects, features, and advantages are further clarified by preferred embodiments described below, and the accompanying drawings as follows.

FIG. 1 is a perspective view showing an example of a coil component according to a first embodiment of the present invention.

FIG. 2 is an exploded perspective view of the coil component according to the first embodiment.

FIG. 3 is a right side view of the coil component according to the first embodiment. Contours of parts of coils, adhesives, and a base unit that cannot be seen due to cores are indicated by dotted lines.

FIG. 4 is a front view of the coil component according to the first embodiment. Contours of the coils, and contours of bottom surfaces of recesses in the cores that cannot be seen due to the cores are indicated by dotted lines.

FIG. 5 is a top view of the coil component according to the first embodiment.

FIG. 6A is a perspective view showing the base unit and terminal members according to the first embodiment. FIG. 6B is a perspective view showing the base unit and the terminal members according to the first embodiment when viewed from another direction.

FIG. 7 is a perspective view of a manufacturing process of the coil component according to the first embodiment.

### DETAILED DESCRIPTION

Various constituent elements of a coil component of the present invention do not need to be individually independent entities. For example, a plurality of constituent elements may be formed as a single member, a single constituent element may be formed by a plurality of members, a certain constituent element may constitute a part of another constituent element, and a part of a certain constituent element and a part of another constituent element may overlap with each other.

In addition, while a manufacturing method of the present invention may be described using a plurality of sequentially described steps, the described sequence is not intended to limit a sequence or a timing of executing the plurality of steps. Therefore, when implementing the manufacturing method of the present invention, the sequence of the plurality of steps can be changed to the extent that such a change does not interfere with contents and a part of or all of the timings at which the plurality of steps are executed may overlap with each other.

Hereinafter, embodiments of the present invention will be described with reference to the drawings. In each drawing, corresponding constituent elements will be denoted by common reference signs and redundant descriptions will not be repeated.

In the present embodiments, front-rear, left-right, and up-down directions are defined and described as shown in the drawings. However, this is conveniently defined in order to briefly describe relative relations among constituent elements and does not limit directions at the time of manufacturing and at the time of use of a product that implements the present invention. The up-down direction in the present embodiments is a direction orthogonal to a surface of a mounting substrate in a case where a coil component is placed on the mounting substrate. When the coil component is placed on a horizontal mounting substrate, the up-down direction and the vertical direction coincide. However, when the coil component is placed on an inclined mounting substrate, the up-down direction is a direction inclined with respect to the vertical direction. The front-rear direction and the left-right direction are sometimes referred to as a lateral direction. In the present embodiments, the front-rear direction coincides with the axial direction of a coil. The left-right direction is sometimes referred to as the width direction of the coil component. The up-down direction is sometimes referred to as the height direction of the coil component or a member in the coil component.

A plane referred to in the present invention means a shape intended to be physically formed into a plane and, naturally, does not need to be a geometrically complete plane.

### First Embodiment

### (Coil Component)

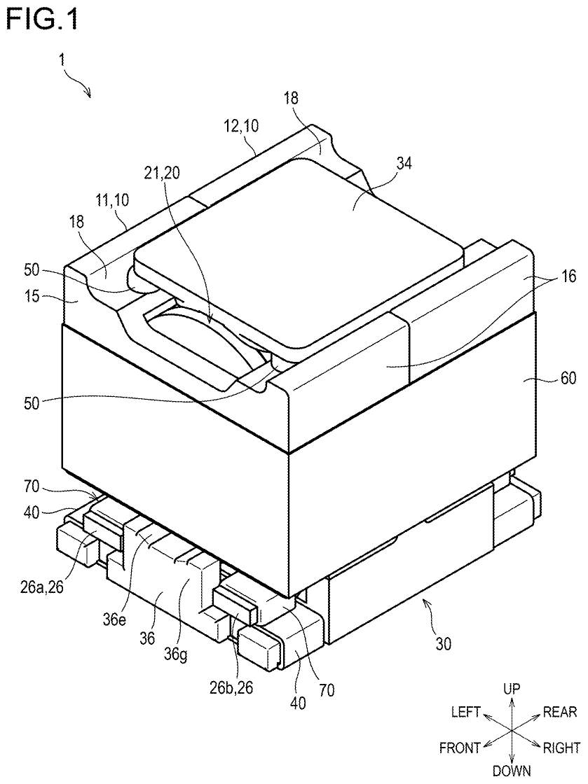

FIG. 1 is a perspective view showing an example of a coil component 1 according to a first embodiment of the present invention.

First, an overview of the coil component 1 in the present embodiment will be described.

The coil component 1 includes a plurality of (two or more) cores 10 (a first core 11 and a second core 12), a plurality of (two or more) coils 20 (a first coil 21 and a second coil 22), and a base unit 30. The plurality of (two or more) coils 20 are spirally arranged around at least respective parts of the plurality of cores 10. The base unit 30 holds the coils 20 and the cores 10. Terminal members 40 are arranged in the base unit 30.

The base unit 30 includes a pedestal portion 36 and a standing portion 38. The terminal members 40 are arranged at the pedestal portion 36. The coils 20 or the cores 10 are placed on the pedestal portion 36. The standing portion 38 is arranged standing in a standing direction (the up-down direction) to intersect a surface of the pedestal portion 36. In addition, the base unit 30 is formed by integrating the pedestal portion 36 and the standing portion 38.

One end surface (an inner end surface 21a, 22a) of each of the plurality of coils 20 faces a corresponding facing surface 38a (a first facing surface 38a1 and a second facing surface 38a2) which is a side surface of the standing portion 38.

When the coil component 1 of the present invention is manufactured, the coil 20 is arranged on the base unit 30 in such a direction that the inner end surface 21a of the coil 20 faces the side surface (the facing surface 38a) of the standing portion 38. In this case, the coil 20 is moved in the axial direction of the coil 20 to be arranged on the base unit 30, and the standing portion 38 provided in the base unit 30 reduces an accidental movement of the coil 20 beyond the side surface of the standing portion 38. That is, the position adjustment of the coil 20 is assisted by the standing portion 38. For example, when the coil 20 is inserted into the base unit 30 as described later, the coil 20 is inserted into the base unit 30 until the inner end surface 21a, 22a of the coil 20 contacts a corresponding side surface of the standing portion 38, and the position of the coil 20 is determined on its own according to the position of the standing portion 38. Even when the coil 20 is inserted into the base unit 30 up to a position immediately before the inner end surface 21a, 22a of the coil 20 contacts the corresponding side surface of the standing portion 38, the standing portion 38 arranged in the base unit 30 can reduce accidental insertion of the coil 20 to the base unit 30 beyond the standing portion 38. That is, it is possible to reduce steps required to adjust the position of the coil 20 relative to the base unit 30 before arranging the coil 20 in the base unit 30. Since the standing portion 38 and the pedestal portion 36 are integrally formed, the need to adjust the position of the standing portion 38 in the pedestal portion 36 is eliminated. This can provide the coil component 1 easy to be manufactured.

Next, the coil component 1 in the present embodiment will be described in detail.

The coil component 1 is an electronic component including the coil 20. The electronic component is a component that can configure a part of an electronic circuit. As the coil component 1, a transformer, an antenna, an inductor, or the like is exemplified. The coil component 1 in the present embodiment is arranged and mounted such that a mounting surface of the terminal member 40 described below is brought into contact with a mounting substrate not shown in the drawings.

The coil 20 is a member obtained by a conductive material being spirally arranged. The coil 20 in the present embodiment is an edgewise coil obtained by a flat wire being spirally arranged, the flat wire having a cross section formed in a flat shape (the cross section having a rectangular shape or an elliptical shape). The coil 20 may be formed by a round wire having a circular cross section. The coil 20 is not limited by a manufacturing method and may be a coil in general obtained by a conductive material being spirally formed. That is, the coil 20 may be formed by spirally arranging the conductive material such that a core portion is hollow. In this case, after the formation of the coil, a core 10 may be inserted into a hollow portion of the coil. The inner surface (a peripheral surface of the flat wire) of a winding portion 28 and the core 10 (in particular, a peripheral surface of a leg portion 13 described below) may be separated from or may be in contact with each other. Alternatively, the coil 20 may be formed by winding the conductive material (coil wire) around the core 10. In this case, the coil wire in the coil 20 may be in press contact with or may be in contact with the core 10 (in particular, the leg portion 13). The coil wire may bite into the core 10.

In the present embodiment, the coil component 1 includes two coils 20 (a first coil 21 and a second coil 22). In the present embodiment, a spiral direction (left-hand thread direction=counterclockwise direction) of the first coil 21 with respect to the axial direction of the first coil 21 is opposite to a spiral direction (right-hand thread direction=clockwise direction) of the second coil 22 with respect to the axial direction of the second coil 22. Alternative to the present embodiment, the spiral direction of the first coil 21 with respect to the axial direction of the first coil 21 may be the same direction as the spiral direction of the second coil 22 with respect to the axial direction of the second coil 22.

In a spiral shape of the coil 20, the direction in which the central axis of the spiral shape extends is referred to as the axial direction of the coil 20 or is simply referred to as the axial direction. In the present embodiment, both of the axial direction of the first coil 21 and the axial direction of the second coil 22 coincide with the front-rear direction.

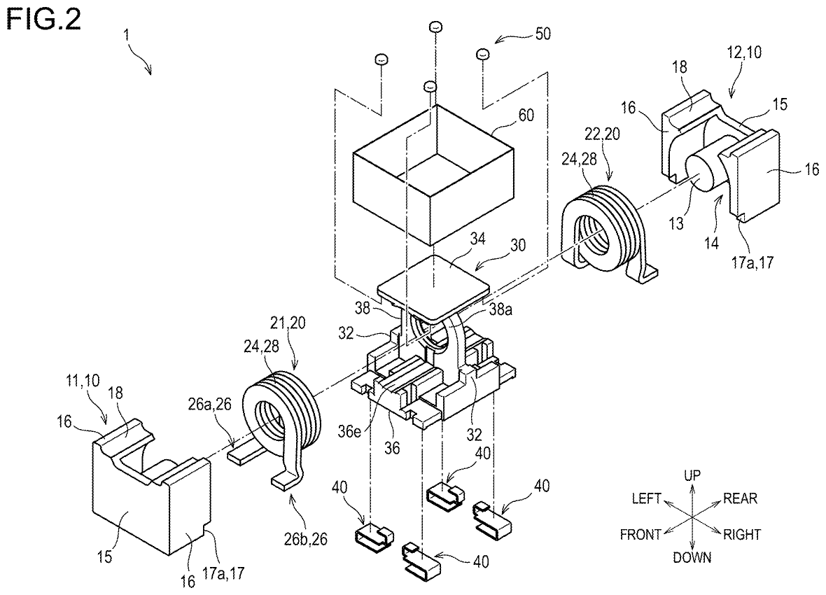

As shown in FIG. 2, the coil 20 in the present embodiment includes the winding portion 28 and two drawn-out portions 26 (a first drawn-out portion 26a and a second drawn-out portion 26b).

The winding portion 28 is a portion having a spiral shape in the coil 20.

The drawn-out portion 26 is a part drawn out from the winding portion 28 in the coil 20. The drawn-out portion 26 is also one end portion of the conductive material (flat wire) forming the coil 20. In the present embodiment, both ends of the flat wire are drawn out from the winding portion 28, and the coil 20 includes the two drawn-out portions 26 (the first drawn-out portion 26a and the second drawn-out portion 26b).

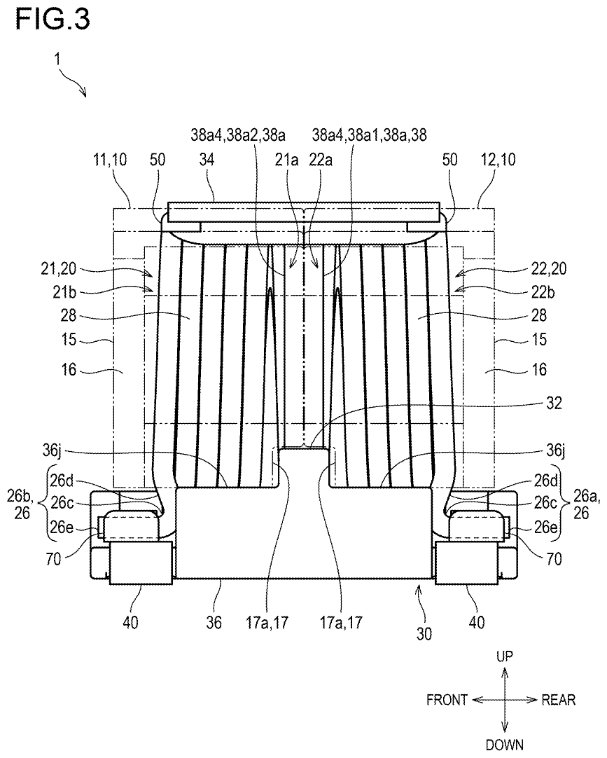

In the present embodiment, as shown in FIG. 3, the drawn-out portions 26 (each of a first drawn-out portion 26a (see FIG. 2) and a second drawn-out portion 26b) extend downward from both respective end portions of the coil 20 (the winding portion 28) in the axial direction. That is, a proximal end portion 26d which is a part of the drawn-out portion 26 (a part on a proximal end side, and also a part on an inward side of the base unit 30) extends in the up-down direction. It is only required that the proximal end portion 26d extends in a direction that has an up-down directional component larger than a lateral component. That is, the proximal end portion 26d may extend in parallel to the up-down direction or may extend to be inclined with respect to the up-down direction.

The drawn-out portion 26 is folded (bent) by a folding portion 26c arranged in a middle of the drawn-out portion 26. A distal end portion 26e which is a part of the drawn-out portion 26 (a part on a distal end side, and also a part on an outward side of the base unit 30) extends in a substantially horizontal direction (in particular, the front-rear direction). More specifically, the drawn-out portion 26 (the distal end portion 26e) extends in the axial direction (the front-rear direction) of the coil 20 along a surface (a bottom surface of an end arrangement recess 36i described below) of the pedestal portion 36 as described below.

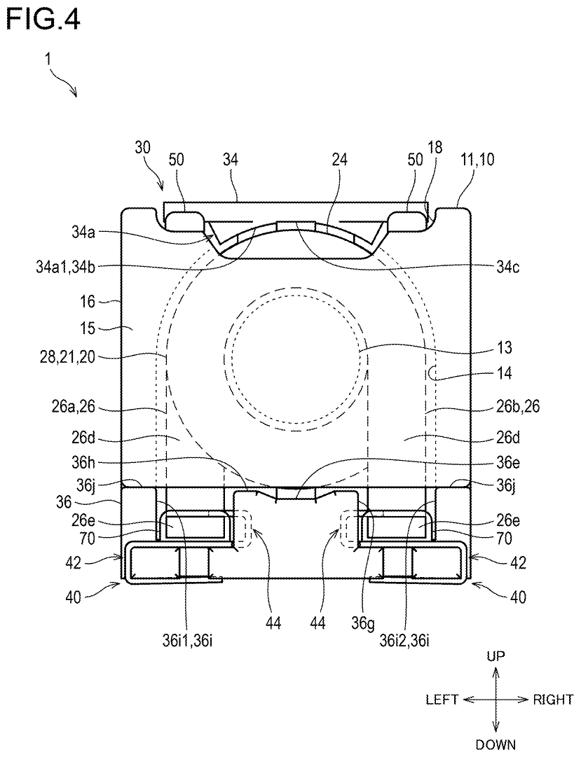

As described above and as shown in FIG. 4, the coil 20 (the winding portion 28) is spirally arranged around at least a part of the core 10. In the present embodiment, the leg portion 13 described below of the core 10 is arranged at a center of the winding portion 28.

The core 10 is a member made of a magnetic material. In the present embodiment, the core 10 is a so-called PQ core as described below. The core 10 may be a so-called I core, E core, U core, or a core having a different shape. In the present embodiment, a plurality of cores 10 have the same shape as each other, but alternative to the present embodiment, the plurality of cores 10 may have different shapes from each other.

In the present embodiment, the plurality of cores 10 are combined to form a closed magnetic path. Specifically, in the present embodiment, the first core 11 and the second core 12 are arranged so that end surfaces of the respective leg portions 13 described below are brought close to each other and end surfaces of respective sidewall portions 16 are brought close to each other.

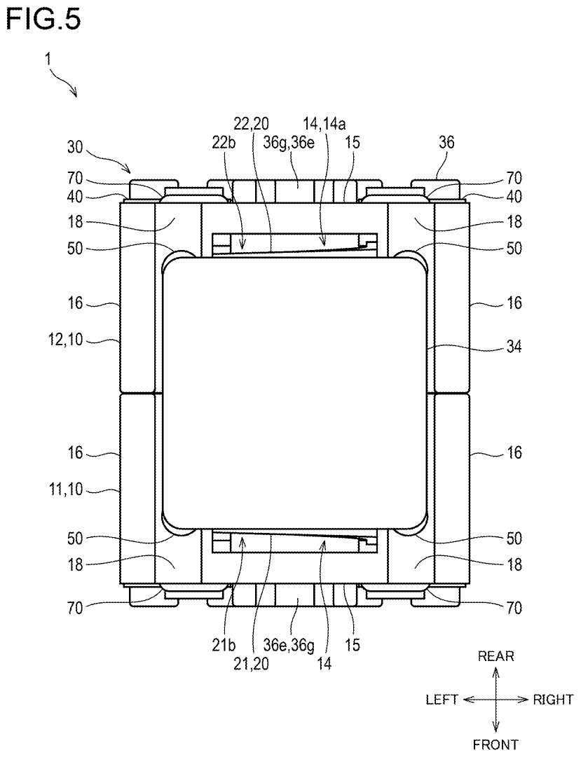

Furthermore, in the present embodiment, as shown in FIG. 5, the end surface of the sidewall portion 16 of the first core 11 and the end surface of the sidewall portion 16 of the second core 12 contact each other. The end surface of the leg portion 13 of the first core 11 and the end surface of the leg portion 13 of the second core 12 contact each other. Alternative to the present embodiment, a gap may be formed between the end surface of the sidewall portion 16 of the first core 11 and the end surface of the sidewall portion 16 of the second core 12, and a gap may be formed between the end surface of the leg portion 13 of the first core 11 and the end surface of the leg portion 13 of the second core 12.

In the present embodiment, as shown in FIG. 2, the core 10 has a rectangular parallelepiped shape as a whole. The core 10 includes the sidewall portion 16, an outward arrangement portion 15, a hollow portion 14, and the leg portion 13. The core 10 covers at least a part of a peripheral surface 24 of the coil 20. The sidewall portion 16 is a portion that covers (surrounds) a part of the peripheral surface 24 of the coil 20 (the winding portion 28). In the present embodiment, a total of two sidewall portions 16 are arranged on both sides of the core 10 in the left-right direction. The sidewall portions 16 are arranged around a part facing sideways (facing the left-right direction) in the peripheral surface of the winding portion 28.

The outward arrangement portion 15 is a part arranged on an outward side of the base unit 30 in the axial direction. A main surface of the outward arrangement portion 15 faces one end surface (an outer end surface) of the coil 20.

The hollow portion 14 is defined by the sidewall portions 16 and the outward arrangement portion 15. The hollow portion 14 can also be referred to as an internal space of the core 10. In other words, in the core 10, a recess is formed which opens on a lateral side and in which the outward arrangement portion 15 forms a bottom portion. The internal space of the formed recess can also be referred to as the hollow portion 14. The coil 20 (in particular, the winding portion 28) is housed in the hollow portion 14. The entire coil 20 may be arranged in the hollow portion 14, or only a part of the coil 20 may be arranged in the hollow portion 14 and another part of the coil 20 may be arranged outside of the hollow portion 14 (for example, outside the core 10). In addition, in the present embodiment, a part of the standing portion 38 is arranged in the hollow portion 14 of the core 10.

The leg portion 13 is a columnar portion formed by protruding from the outward arrangement portion 15 in the front-rear direction (toward the inward side in the base unit 30). The leg portion 13 is arranged inside the winding portion 28 in the coil 20.

As shown in FIG. 4, the base unit 30 is a member that holds the coils 20 and the cores 10. The base unit 30 is made of an insulating material. In the present embodiment, the base unit 30 is made of a resin.

The base unit 30 holds directly or indirectly the coils 20 and the cores 10. The base unit 30 holding the coils 20 and the cores 10 means that the base unit 30 supports directly or indirectly the coils 20 or the cores 10. In the present embodiment, the base unit 30 holds directly the cores 10. Specifically, the cores 10 are arranged directly on the base unit 30 (in particular, the pedestal portion 36), and the cores 10 are supported on the base unit 30. Alternative to the present embodiment, the cores 10 may be held indirectly on the base unit 30 via another member. On the other hand, in the present embodiment, the base unit 30 holds indirectly the coils 20. Specifically, the coils 20 are held on the base unit 30 via the terminal members 40 described below. In detail, the coils 20 are placed on the terminal members 40 connected (coupled) to the base unit 30, and are connected (fixed) to the terminal members 40. Alternative to the present embodiment, the terminal members 40 may be placed on the base unit 30 so as to be held directly on the base unit 30.

The coils 20 or the cores 10, or both of them are placed on the pedestal portion 36. As shown in FIG. 4, in the present embodiment, the cores 10 are placed on the pedestal portion 36. More specifically, the pedestal portion 36 includes a pair of two elevated portions 36j at both end portions in the left-right direction. The cores 10 are placed on upper surfaces of the elevated portions 36j. The coils 20 are arranged on the terminal members 40 described below, and are supported indirectly on the pedestal portion 36 via the terminal members 40.

As shown in FIG. 2, the pedestal portion 36 in the present embodiment is a portion having a substantially flat plate shape extending in the horizontal direction. In other words, the pedestal portion 36 is a member including a lower surface portion of the base unit 30.

As shown in FIG. 2, the standing portion 38 intersects a surface of the pedestal portion 36, and stands in the standing direction (the up-down direction). Here, the surface of the pedestal portion 36 which an extending direction of the standing portion 38 intersects may be a virtual upper surface (a main surface facing upward) in the pedestal portion 36 having a substantially flat plate shape extending in the horizontal direction. The standing portion 38 may stand orthogonally to the surface of the pedestal portion 36 or may stand in an oblique direction. In the present embodiment, the standing direction in which the standing portion 38 stands is the up-down direction.

The standing portion 38 in the present embodiment is formed to protrude upward from a center portion of the pedestal portion 36. Specifically, the standing portion 38 is arranged at the center portion of the pedestal portion 36 in the front-rear direction. Alternatively, the standing portion 38 may be arranged at a peripheral edge portion of the pedestal portion 36.

The standing portion 38 in the present embodiment is a flat plate portion having a main surface facing the front-rear direction. Alternative to the present embodiment, the standing portion 38 may have a columnar shape.

The pedestal portion 36 and the standing portion 38 being integrated to form the base unit 30 means that the pedestal portion 36 and the standing portion 38 are seamlessly made of the same material. More specifically, the pedestal portion 36 and the standing portion 38 in the present embodiment are formed simultaneously by pouring a resin into one mold.

The terminal member 40 is an electrode member electrically connected to the coil 20 (in particular, an end of its drawn-out portion 26). The terminal member 40 serves as an input electrode or an output electrode of the coil component 1. The terminal member 40 is made of a conductive member such as metal. Phosphor bronze is exemplified as metal forming the terminal member 40.

The terminal member 40 in the present embodiment is formed by folding a flat plate made of the conductive material. Alternative to the present embodiment, the terminal member 40 may be formed in a shape having a bent portion by pouring a melted metal into a mold or the like.

The terminal member 40 is arranged at the base unit 30 by hooking a hook portion on a part of the base unit 30 (a part of the pedestal portion 36) as described below. Alternative to the present embodiment, the terminal member 40 may be embedded in the base unit 30 or may be fixed with a suitable adhesive or the like.

In the present embodiment, the coil component 1 is mounted on the mounting substrate by grounding a lower surface of the terminal member 40 (a lower surface of a first hook portion 42 described below) to the mounting substrate.

As shown in FIG. 3, the inner end surfaces 21a and 22a in the plurality of coils 20 face the first facing surface 38a1 and the second facing surface 38a2, respectively. The end surface of the coil 20 is a virtual surface facing the axial direction in an end portion of the coil 20 in the axial direction. The inner end surface 21a, 22a of the coil 20 is an end surface facing a center side of the base unit 30 (the standing portion 38 side) among the end surfaces of the coil 20.

On the other hand, the first facing surface 38a1 and the second facing surface 38a2 are parts of surfaces (side surfaces) facing sideways among surfaces of the standing portion 38. In the present embodiment, the first facing surface 38a1 and the second facing surface 38a2 are surfaces (main surfaces) facing the front-rear direction in the standing portion 38.

The facing surface 38a may be a flat surface or may be a curved surface. The facing surface 38a in the standing portion 38 facing the inner end surface 21a, 22a of the coil 20 is not limited to two flat surfaces being parallel to each other. It is only required that the facing surface 38a in the standing portion 38 and the inner end surface 21a, 22a of the coil 20 overlap with each other in a predetermined direction (for example, the front-rear direction).

In the present embodiment, the first facing surface 38a1 and the second facing surface 38a2 are arranged along each other. That is, the first facing surface 38a1 and the second facing surface 38a2 are arranged substantially parallel to each other. In this case, the axial direction of the first coil 21 and the axial direction of the second coil 22 are substantially parallel to each other.

In the present embodiment, the inner end surface 21a of the first coil 21 and the inner end surface 22a of the second coil 22 face each other across the standing portion 38. That is, the inner end surface 21a of the first coil 21 faces the inner end surface 22a of the second coil 22 in the axial direction (the front-rear direction) of the first coil 21. In other words, at least a part of the inner end surface 21a of the first coil 21 and at least a part of the inner end surface 22a of the second coil 22 overlap with each other when viewed in the front-rear direction. More specifically, in the present embodiment, an axial center of the first coil 21 and an axial center of the second coil 22 are arranged on the same straight line.

In the present embodiment, the facing surface 38a of the standing portion 38 and the inner end surface 21a, 22a of the coil may be in contact with each other or may be separated from each other.

The shape of the standing portion 38 is not limited to the above-described shape, and an arrangement relationship between the standing portion 38 and the two coils 20 is not limited to the above-described one.

Alternative to the present embodiment, the first facing surface 38a1 and the second facing surface 38a2 may be arranged so as to intersect each other. When the standing portion 38 has a quadrangular prism shape, for example, each of adjacent side surfaces may be the first facing surface 38a1 or the second facing surface 38a2. In this case, the two coils 20 are arranged so that the respective axial directions are intersect each other (for example, at 90 degrees). Alternatively, in the standing portion 38, a part of one main surface facing sideways may serve as the first facing surface 38a1, and the other part may serve as the second facing surface 38a2. In this case, the two coils 20 are arranged side by side.

Alternative to the present embodiment in which the two coils 20 are coaxially arranged, the axial centers of the two coils 20 may be offset from each other in the left-right direction or in the up-down direction.

As shown in FIG. 3, in the present embodiment, a locking portion 32 is provided in the base unit 30. The locking portion 32 is arranged between the first core 11 (its sidewall portion 16) and the second core 12 (its sidewall portion 16) in the axial direction.

When the first coil 21 and the second coil 22 are arranged at the base unit 30 in the present embodiment, each of the first coil 21 and the second coil 22 is inserted into the base unit 30 from one side to the other side (in the forward direction or in the rearward direction) in the axial direction. Since the locking portion 32 is arranged between the first coil 21 and the second coil 22 in the axial direction, when the first coil 21 and the second coil 22 are inserted into the base unit 30 in the axial direction, the first coil 21 and the second coil 22 contact the locking portion 32, and the insertion is stopped. That is, during a process of inserting the coils 20 into the base unit 30, the first coil 21 and the second coil 22 can be positioned by the locking portion 32.

The locking portion 32 is a portion or a member that can lock the movement of each of the first core 11 and the second core 12 in the axial direction. That is, the locking portion 32 overlaps with each of at least a part of the first core 11 and at least a part of the second core 12 in the axial direction.

In the present embodiment, the locking portion 32 is formed in the base unit 30 so as to be adjacent to the standing portion 38 and the elevated portion 36j in the pedestal portion 36. More specifically, the pedestal portion 36 protrudes from the standing portion 38 in the left-right direction and protrudes upward from the elevated portion 36j.

Alternative to the present embodiment, the locking portion 32 may be formed in another place of the base unit 30. For example, the locking portion 32 may be formed to protrude outward in the left-right direction from the standing portion 38 in a part of the upper side of the standing portion 38. Alternatively, the locking portion 32 may be formed to protrude upward from a part on the outward side of the pedestal portion 36 in the left-right direction.

In the present embodiment, the core 10 (in particular, the sidewall portion 16) has a recess (a housing recess 17) that can be fitted to the locking portion 32. The housing recess 17 is formed by causing an end portion of the core 10 (one end portion on the inward side of the base unit 30 in the front-rear direction) to be depressed outward with respect to the base unit 30 in the front-rear direction. Here, the outward side of the base unit 30 in a predetermined direction (in particular, the front-rear direction) is referred to as a peripheral edge portion side of the base unit 30 in the predetermined direction, and the inward side of the base unit 30 in the predetermined direction is referred to as a center side of the base unit 30 in the predetermined direction. In the present embodiment, the housing recess 17 which opens toward the inward side of the base unit 30 is formed in a lowermost end portion of the core 10. In addition, the housing recess 17 in the present embodiment also opens downward.

At least a part of the locking portion 32 is arranged inside the housing recess 17. In the present embodiment, a part of the locking portion 32 is arranged in the housing recess 17 of the first core 11, and another part is arranged in the housing recess 17 of the second core 12. As a result, the whole of the locking portion 32 is arranged in a space formed by the housing recess 17 of the first core 11 and the housing recess 17 of the second core 12.

As described above, the cores 10 (the first core 11 and the second core 12) each include the housing recess 17 that can be fitted to the locking portion 32, so that the locking portion 32 can be arranged between the first core 11 and the second core 12 without interfering with the first core 11 and the second core 12 while the first core 11 and the second core 12 contact each other.

A part of the surface of the core 10 is an abutment surface 17a that defines the housing recess 17. The abutment surface 17a is a surface facing the locking portion 32 in the axial direction (the front-rear direction) among the surfaces of the core 10 that define the housing recess 17. The abutment surface 17a may contact the locking portion 32 or may be separated from the locking portion 32 in the front-rear direction.

Here, the abutment surface 17a is a surface facing the inward side of the base unit 30 in the front-rear direction, and may be a curved surface or may be a flat surface. The surface of the locking portion 32 facing the abutment surface 17a may be a curved surface or may be a flat surface.

As shown in FIG. 3, in the present embodiment, the abutment surface 17a of the first core 11 and the locking portion 32 are separated from each other in the front-rear direction, and the abutment surface 17a of the second core 12 and the locking portion 32 are separated from each other in the front-rear direction. More specifically, a separation distance between the abutment surface 17a of the first core 11 and the locking portion 32 in the front-rear direction is the same as a separation distance between the abutment surface 17a of the second core 12 and the locking portion 32 in the front-rear direction. That is, the first core 11 and the second core 12 are arranged at a center of the base unit 30.

Alternative to the present embodiment, the first core 11 and the second core 12 may be arranged not to be equidistant from the center of the base unit 30 so that the first core 11 and the second core 12 are offset from each other in the front-rear direction. For example, the separation distance between the abutment surface 17a of the first core 11 and the locking portion 32 in the front-rear direction may be larger than the separation distance between the abutment surface 17a of the second core 12 and the locking portion 32 in the front-rear direction. Alternatively, the abutment surface 17a of the first core 11 and the locking portion 32 may be separated from each other in the front-rear direction and the abutment surface 17a of the second core 12 and the locking portion 32 may contact each other. When the first core 11 and the second core 12 are arranged in this manner to be offset from each other in the front-rear direction, in the arrangement positions of the first core 11 and the second core 12, a manufacturing error between the coil components 1 can be reduced.

The position at which the locking portion 32 is formed may be any position between the first core 11 and the second core 12, and may be different from that in the present embodiment. For example, the locking portion 32 may be formed as a protruding portion that is separated from the pedestal portion 36 and protrudes from the standing portion 38 in the left-right direction. Alternatively, the locking portion 32 may be formed as a protruding portion that is separated from the standing portion 38 and protrudes upward from the pedestal portion 36 (for example, the elevated portion 36j).

In the present embodiment, as shown in FIG. 2, the base unit 30 further includes a top plate portion 34. The top plate portion 34 is arranged so that the standing portion 38 is interposed between the top plate portion 34 and the pedestal portion 36 in the standing direction (the up-down direction). That is, the top plate portion 34 is formed adjacent to an upper end portion of the standing portion. The top plate portion 34 is formed integrally with the standing portion 38. That is, there is no seam between the top plate portion 34 and the standing portion 38, and the top plate portion 34 and the standing portion 38 are made of the same material.

As shown in FIG. 5, the top plate portion 34 covers at least a part of the cores 10 when viewed from the top plate portion 34 side (the upper side) in the standing direction (the up-down direction).

Providing the top plate portion 34 can protect the cores 10 satisfactorily. An upper surface of the top plate portion 34 is a flat surface as described below. When the upper surface of the top plate portion 34 serving as the upper surface of the coil component 1 is a flat surface, the flat surface is suctioned with a mounter or the like, which makes it possible to transfer the coil component 1.

In the present embodiment, the top plate portion 34 has a flat plate shape extending in the lateral direction. That is, the top plate portion 34 is arranged substantially parallel to the pedestal portion 36. The extending direction of the top plate portion 34 intersects the standing direction of the standing portion.

The top plate portion 34 covering at least a part of the cores 10 when viewed from above means that at least a part of the top plate portion 34 and at least a part of the cores 10 overlap with each other in the standing direction (the up-down direction). In the present embodiment, the top plate portion 34 covers both of at least a part of the first core 11 and at least a part of the second core 12.

In the present embodiment, the main surface (the upper surface) facing upward of the top plate portion 34 is a flat surface. The shape of the top plate portion 34 is a rectangular shape when viewed in the up-down direction. The rectangular shape of the top plate portion 34 when viewed in the up-down direction has a shape and dimensions which are smaller than a rectangular shape of the pedestal portion 36 when viewed in the up-down direction.

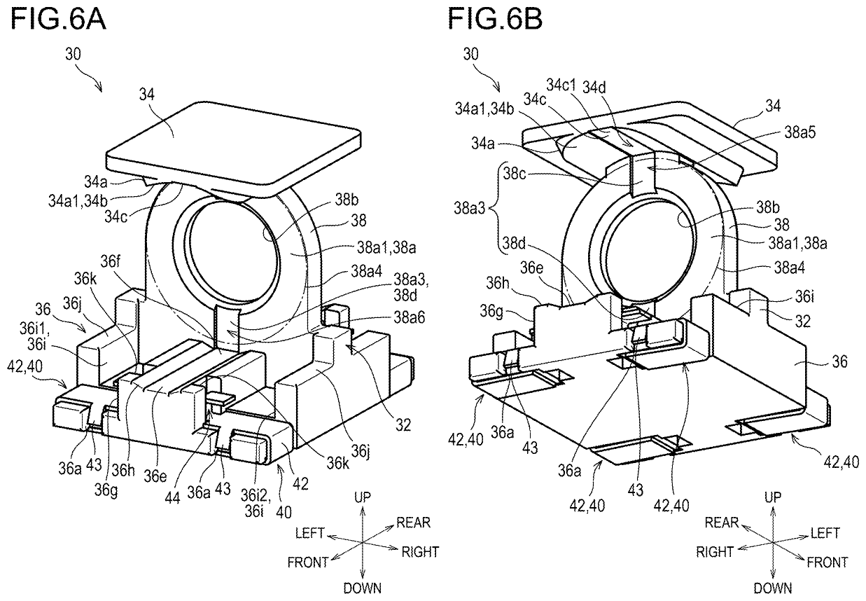

As shown in FIGS. 6A and 6B, a first recessed groove 38a3 is formed in the facing surface 38a of the standing portion 38. The first recessed groove 38a3 extends in the standing direction (the up-down direction). The first recessed groove 38a3 extends between the inside of a region (a facing region 38a4) facing the inner end surface 21a, 22a of the coil in the facing surface 38a and a peripheral edge of the facing region 38a4.

The coil component 1 can be assembled satisfactorily by forming the above-described first recessed groove 38a3. Specifically, when the core 10 is arranged at the base unit 30 at which the coil 20 is arranged, the air pressure in the hollow portion 14 of the core 10 may increase due to insertion of the coil 20 into the internal space (the hollow portion 14) of the core 10. Providing the first recessed groove 38a3 in the standing portion 38 enables air in the hollow portion 14 to escape to the outside of the hollow portion 14 through the first recessed groove 38a3 even when the coil 20 is inserted into the hollow portion 14 of the core 10. This satisfactorily reduces assembly failure of the coil component 1.

Since the coil 20 is heated during the use of the coil component 1, hot air may stay in the internal space (the hollow portion 14) of the core 10. Providing the first recessed groove 38a3 enables the hot air to be discharged to the outside of the hollow portion 14 through the first recessed groove 38a3.

The first recessed groove 38a3 is a recess formed by the facing surface 38a of the standing portion 38 depressed toward the inside of the standing portion 38 in the axial direction.

In the present embodiment, a hole (a core insertion hole 38b) is formed in a center portion of the standing portion 38. The leg portion 13 of the core 10 is inserted into the core insertion hole 38b. The first recessed groove 38a3 in the present embodiment is divided into an upper groove 38c and a lower groove 38d with the core insertion hole 38b interposed therebetween in the up-down direction. As shown in FIG. 6B, the upper groove 38c extends from the core insertion hole 38b to a boundary between the standing portion 38 and the top plate portion 34 (to the upper end portion of the standing portion 38). As shown in FIG. 6A, the lower groove 38d extends from the core insertion hole 38b to a boundary between the standing portion 38 and the pedestal portion 36 (to the lower end portion of the standing portion 38). In the present embodiment, the upper groove 38c and the lower groove 38d are arranged on the same straight line, but the present invention is not limited thereto. The lower groove 38d may be arranged to avoid the center line of the upper groove 38c.

It is only required that the extending direction of the first recessed groove 38a3 has a standing directional component larger than the lateral component. That is, the first recessed groove 38a3 may extend in parallel to the standing direction or may extend to be slightly inclined with respect to the standing direction. In the present embodiment, the first recessed groove 38a3 extends from the lower end to the upper end of the standing portion 38 with the core insertion hole 38b interposed therebetween, but the present invention is not limited thereto. For example, the standing portion 38 may include only the upper groove 38c or only the lower groove 38d.

The facing region 38a4 is a region that overlaps with the inner end surface 21a, 22a of the coil 20 in the axial direction in the facing surface 38a. The first recessed groove 38a3 may terminate at the peripheral edge of the facing region 38a4 or may extend to the outside of the facing region 38a4 to terminate at the outside.

In the first recessed groove 38a3 in the present embodiment, the dimension in the width direction (the left-right direction) is smaller than the dimension in the up-down direction, and the first recessed groove 38a3 has a shape elongated in the up-down direction. Alternative to the present embodiment, in the first recessed groove 38a3, the dimension in the width direction may be larger than the dimension in the up-down direction.

As shown in FIG. 6B, in the present embodiment, a second recessed groove 34c is formed in a lower surface 34b (which is an inner surface facing the inside of the base unit 30 and is also an inner surface facing a peripheral surface of the coil 20) facing the pedestal portion 36 side (the lower side) in the standing direction (the up-down direction) in the top plate portion 34. The second recessed groove 34c extends in the axial direction of the coil 20. One end portion (one end portion in the axial direction, or the inner end portion 34d which is an end portion on the inward side in the axial direction) of the second recessed groove 34c communicates with one end portion (an upper end portion 38a5) of the first recessed groove 38a3.

Providing the second recessed groove 34c in the top plate portion 34 can reduce an increase in air pressure in the internal space (the hollow portion 14) of the core 10 at the time of assembly of the coil component 1 even when the top plate portion 34 and the peripheral surface 24 of the coil 20 are brought close to each other. The hot air that stays in the internal space (the hollow portion 14) of the core 10 during the use of the coil component 1 can escape through the second recessed groove 34c.

Here, the lower surface 34b facing downward in the top plate portion 34 is a surface facing downward among the surfaces of the top plate portion 34. The lower surface 34b in the present embodiment also includes a surface of a top plate protruding portion 34a described below.

The second recessed groove 34c is a recess formed by the lower surface 34b of the top plate portion 34 depressed upward. In the present embodiment, the second recessed groove 34c is formed in the top plate protruding portion 34a described below in the top plate portion 34. Accordingly, a space can be provided between the top plate protruding portion 34a and the peripheral surface 24 of the coil 20, which are particularly brought close to each other.

When viewed in the up-down direction, the second recessed groove 34c may extend to the outward side in the axial direction with respect to the end surface (the outer end surface 21b, 22b (see FIG. 3)) on the outward side in the axial direction among the end surfaces of the coil 20, or may terminate at the inward side in the axial direction with respect to the outer end surface 21b, 22b.

In the present embodiment, as shown in FIG. 5, the outer end surface 21b, 22b of the coil 20 in the present embodiment is arranged on the outward side in the axial direction (the front-rear direction) with respect to the peripheral edge portion of the top plate portion 34 when viewed in the up-down direction. In the present embodiment thus configured, the second recessed groove 34c (see FIG. 6B) terminates at the inward side in the axial direction with respect to the outer end surface 21b, 22b. Specifically, as shown in FIG. 6B, the second recessed groove 34c preferably extends to an end portion (an outer end portion 34c1) on the outward side of the top plate portion 34 (the top plate protruding portion 34a) in the axial direction. Alternative to the present embodiment, when the outer end surface 21b, 22b of the coil 20 is arranged on the inward side in the axial direction with respect to the peripheral edge portion of the top plate portion 34 when viewed from above, the second recessed groove 34c may extend to the end portion on the outward side of the top plate portion 34 in the axial direction or may terminate in the middle in the axial direction without extending to the end portion.

Here, an end portion of one groove communicating with an end portion of another groove means that a hollow space of the one groove (in particular, its end portion) communicates with a hollow space of another groove (in particular, its end portion). Here, the end portion of one groove communicating with the end portion of another groove is not limited to the end portions being adjacent to each other to directly communicate with each other, and includes an open space being provided between the end portion of one groove and the end portion of another groove so that the end portion of one groove and the end portion of another groove indirectly communicate with each other via the open space. The open space is a hollow space for causing the end portion of one groove to spatially communicate with the end portion of another groove. In particular, the open space is a space on the extension of one groove in the extending direction of the one groove or a space on the extension of another groove in the extending direction of the other groove, and is preferably an open space in which a part of the base unit is not arranged.

In the present embodiment, the inner end portion 34d of the second recessed groove 34c directly communicates with the upper end portion 38a5 of the first recessed groove 38a3. That is, in the top plate portion 34, the second recessed groove 34c extends to the upper end portion of the standing portion 38, and the inner end portion 34d of the second recessed groove 34c is adjacent to the upper end portion 38a5 of the first recessed groove 38a3.

Alternatively, the inner end portion 34d of the second recessed groove 34c may communicate with the upper end portion 38a5 of the first recessed groove 38a3 (the upper groove 38c) via the open space. For example, unlike the shape of the top plate protruding portion 34a in the present embodiment, there is a case where the top plate protruding portion 34a is provided only on a part of the outward side of the top plate portion 34 in the axial direction and is not provided on a part of the inward side of the top plate portion 34. In this case, a part of the inward side of the top plate portion 34 in the axial direction in which the top plate protruding portion 34a is not provided is further depressed upward than the top plate protruding portion 34a to form an open space. In a case where the inner end portion 34d of the second recessed groove 34c is adjacent to the open space and the upper end portion 38a5 of the first recessed groove 38a3 is also adjacent to the open space, it can be said that the inner end portion 34d of the second recessed groove 34c and the upper end portion 38a5 of the first recessed groove 38a3 communicate with each other.

As shown in FIG. 6A, in the present embodiment, a third recessed groove 36e is formed in an upper surface facing the top plate portion 34 side (the upper side) in the standing direction (the up-down direction) in the pedestal portion 36. The third recessed groove 36e extends in the axial direction (the front-rear direction) of the coil 20. One end portion (which is an inner end portion 36f on the inside of the base unit 30 in the axial direction and is an inner end portion 36f also serving as an end portion on the standing portion 38 side) of the third recessed groove 36e communicates with one end portion (a lower end portion 38a6) of the first recessed groove 38a3.

As described above, the hollow portion 14 communicates with the outside by the third recessed groove 36e. Accordingly, in a manufacturing process of the coil component 1, when the coil 20 is inserted into the internal space (the hollow portion 14) of the core 10, it is possible to reduce an accidental increase in air pressure in the hollow portion 14. When the temperature of the hollow portion 14 of the core 10 rises during the use of the coil component 1, air is supplied into the hollow portion 14 through the third recessed groove 36e, which makes it possible to lower the temperature of the hollow portion 14.

An upper surface facing upward in the pedestal portion 36 is a surface facing upward among the surfaces of the pedestal portion 36. In the pedestal portion 36 in the present embodiment having a pedestal protruding portion 36g, the upper surface also includes a surface (in particular, a protruding end surface 36h) of the pedestal protruding portion 36g. In the present embodiment, the third recessed groove 36e is formed on the pedestal protruding portion 36g. Accordingly, at a position where the peripheral surface 24 of the coil 20 and the pedestal portion 36 may be brought closest to each other, the coil 20 and the pedestal portion 36 can be separated from each other to provide a space through which air or the like passes.

In the present embodiment, the inner end portion 36f of the third recessed groove 36e directly communicates with the lower end portion 38a6 of the first recessed groove 38a3 (the lower groove 38d). That is, in the pedestal portion 36, the third recessed groove 36e extends to the lower end portion of the standing portion 38, and the inner end portion 36f of the third recessed groove 36e and the lower end portion 38a6 of the first recessed groove 38a3 are adjacent to each other.

Alternative to the present embodiment, the inner end portion 36f of the third recessed groove 36e may indirectly communicate with the lower end portion 38a6 of the first recessed groove 38a3 (the lower groove 38d). For example, the inner end portion 36f of the third recessed groove 36e may indirectly communicate with the lower end portion 38a6 of the first recessed groove 38a3 (the lower groove 38d) via the open space.

In the present embodiment, as shown in FIG. 4, the coil 20 is exposed from the core 10 when viewed from the outward side in the axial direction. Accordingly, the cooling of the coil 20 heated during the use is accelerated. Specifically, the upper end portion of the winding portion 28 of the coil 20 is exposed from the upper end portion of the core 10. The lower end portion of the winding portion 28 of the coil 20 is exposed from the lower end portion of the core 10. Since both of the upper end portion and the lower end portion of the winding portion 28 are exposed, outside air can flow into the hollow portion 14 from below the core 10, and the outside air can flow out to the outside of the hollow portion 14 from above the core 10. Accordingly, the cooling of the winding portion 28 arranged in the hollow portion 14 is accelerated. Alternative to the present embodiment, only the upper end portion or only the lower end portion of the winding portion 28 when viewed from the outward side in the axial direction, or the other portions thereof may be exposed from the core 10.

In the present embodiment, as shown in FIG. 5, furthermore, the hollow portion 14 is exposed from the top plate portion 34 when viewed from the top plate portion 34 side (the upper side) in the standing direction (the up-down direction). That is, in the present embodiment, the hollow portion 14 is visible from above.

Since the upper side of the hollow portion 14 opens, the hot air in the internal space (the hollow portion 14) of the core 10 can be discharged.

In the present embodiment, a part of the hollow portion 14 and the top plate portion 34 do not overlap with each other in the up-down direction. The other members in the coil component 1 are not arranged above the part of the hollow portion 14. Therefore, the hollow portion 14 is not exposed from the top plate portion 34 when viewed from above.

As shown in FIG. 2, in the core 10 in the present embodiment, the sidewall portion 16 is not arranged above the hollow portion 14, and the hollow portion 14 opens upward. Therefore, in the present embodiment, a part of the hollow portion 14 which does not overlap with the top plate portion 34 in the up-down direction is visible from above.

In the present embodiment, as shown in FIG. 5, a part of the hollow portion 14 is arranged on the outward side with respect to the top plate portion 34 in the axial direction. In other words, a part of the hollow portion 14 on the outward side in the axial direction is exposed from the top plate portion 34 when viewed from above. That is, a part of the hollow portion 14 on the outward side communicates with a space above the coil component 1. As a result, air that has flowed into the hollow portion 14 from the third recessed groove 36e through the first recessed groove 38a3 moves from the inward side to the outward side in the axial direction, and is released to the outside of the coil component 1 from an opening 14a (an opening of the hollow portion 14 defined by the core 10 and the top plate portion 34) of the hollow portion 14 on the outward side. That is, the air that has flowed into the hollow portion 14 is released to the outside after sufficiently circulating in the hollow portion 14. Accordingly, the inside of the hollow portion 14 is sufficiently cooled.

In the present embodiment, as shown in FIG. 4, the protruding portions (the top plate protruding portion 34a and the pedestal protruding portion 36g) are formed in the top plate portion 34 and the pedestal portion 36, respectively. The protruding end surfaces 34a1 and 36h of the protruding portions extend in the axial direction (the front-rear direction) of the coil 20 along a part of the peripheral surface 24 of the coil 20.

In the manufacturing process of the coil component 1, the protruding end surfaces 34a1 and 36h serve as guides, so that the coil 20 is easily inserted into the hollow portion 14 of the core 10.

In the present embodiment, the top plate protruding portion 34a is a portion that protrudes toward (downward) a side on which the coil 20 is arranged from a flat plate portion of the top plate portion 34. The top plate protruding portion 34a is formed at a center portion of the top plate portion 34 in the left-right direction. That is, the top plate protruding portion 34a protrudes further downward than both end portions of the top plate portion 34 in the left-right direction.

In the present embodiment, the pedestal protruding portion 36g is a portion that protrudes toward (upward) a side on which the coil 20 is arranged from a flat plate portion of the pedestal portion 36. The pedestal protruding portion 36g is formed at a center portion of the pedestal portion 36 in the left-right direction. That is, the pedestal protruding portion 36b protrudes further upward than a bottom surface of the end arrangement recess 36i described below. The pedestal protruding portion 36g is arranged between a pair of two end arrangement recesses 36i.

The protruding end surfaces 34a1, 36h are a surface facing the protruding direction of a protruding portion in the surface of the protruding portion. That is, the protruding end surface 34a1 is a lower surface in the top plate protruding portion 34a, and the protruding end surface 36h is an upper surface in the pedestal protruding portion 36g.

The protruding end surfaces 34a1, 36h being along a part of the peripheral surface of the coil 20 means approximate concave and convex shapes (concave and convex positions and depths) of the protruding end surfaces 34a1, 36h coinciding with an arc shape of the peripheral surface 24 of the coil 20. Since the protruding end surfaces 34a1, 36h of the protruding portions are along the arc shape of the peripheral surface 24 of the coil 20, the protruding end surfaces 34a1, 36h have a shape depressed in a direction opposite to the protruding direction of the protruding portions. The protruding end surface 34a1 of the top plate protruding portion 34a and the protruding end surface 36h of the pedestal protruding portion 36g are depressed upward and downward, respectively. The recessed grooves on the protruding end surfaces 34a1, 36h extend in the axial direction (the front-rear direction). The bottom surface (which is also referred to as a top surface in the protruding end surface 34a1) of the recessed groove is arranged above the end portion of the protruding end surface 34a1 in the left-right direction. The recessed groove makes it difficult for the coil 20 to shift in the left-right direction when the coil 20 is inserted into the base unit 30.

The protruding end surfaces 34a1, 36h may be a curved surface or may be a surface formed to be adjacent to a flat surface. In the present embodiment, the protruding end surface 34a1 in the top plate protruding portion 34a is a curved surface. The protruding end surface 36h in the pedestal protruding portion 36g includes a bottom surface and a pair of wall surfaces that define the third recessed groove 36e, and each of the bottom surface and the wall surfaces is a flat surface.

In the present embodiment, as shown in FIG. 4, a top plate arrangement recess 18 is formed in a part of the core 10 on the top plate portion 34 side (the upper side) in the standing direction (the up-down direction). The top plate arrangement recess 18 is a recess that is depressed toward the pedestal portion 36 side (downward) in the standing direction (the up-down direction). As shown in FIG. 5, the top plate arrangement recess 18 extends in the axial direction (the front-rear direction) of the coil 20.

At least a part of the top plate portion 34 is arranged inside the top plate arrangement recess 18.

With the above-described configuration, in the manufacturing process of the coil component 1, the top plate portion 34 is fitted in the top plate arrangement recess 18, so that the insertion of the core 10 into the base unit 30 in the axial direction is guided.

As shown in FIG. 5, the top plate arrangement recess 18 in the present embodiment is formed across both end portions of the core in the front-rear direction. The top plate portion 34 is arranged across both of the top plate arrangement recess 18 in the first core 11 and the top plate arrangement recess 18 in the second core 12. Alternative to the present embodiment, the top plate portion 34 may be arranged only in the top arrangement recess 18 provided in any one of the cores 10.

As shown in FIG. 4, in the present embodiment, only the lower portion of the top plate portion 34 is arranged in the top plate arrangement recess 18, and the upper portion of the top plate portion 34 is arranged on the outside of the top plate arrangement recess 18 (the space above the top plate arrangement recess 18). Accordingly, the top plate portion 34 can protect the cores 10.

Alternative to the present embodiment, a part of the upper surface of the top plate portion 34 may be arranged in the top plate arrangement recess 18.

In the present embodiment, as shown in FIG. 4, the terminal member 40 includes two hook portions (the first hook portion 42 and the second hook portion 44) each having a hook shape. The protruding direction of the hook shape in the first hook portion 42 is a direction opposite to the protruding direction of the hook shape in the second hook portion 44.

A part of the pedestal portion 36 is arranged while be held by the first hook portion 42 in the standing direction (the up-down direction). The end portion of the coil 20 is arranged while be held by the second hook portion 44 in the standing direction (the up-down direction).

The two hook portions in the present embodiment clamp the coil 20 and the base unit 30, and assists in preventing the terminal member 40 from coming off.

Here, the hook shape is a shape having a protruding shape (a U-shape) formed by folding to bend a distal end toward a proximal end side. In other words, a part having the hook shape can hook another member by interposing the other member between a part on the distal end side and a part on the proximal end side of the part.

The protruding direction of the hook shape is a direction facing the bent distal end side having the protruding shape in a part having the hook shape. It can be also said that the hook shape opens in the direction opposite to the protruding direction. In the present embodiment, the protruding direction of the first hook portion 42 is an outward direction in the left-right direction, and the protruding direction of the second hook portion 44 is an inward direction in the left-right direction.

In the present embodiment, the terminal member 40 has an S shape (also including an inverted S shape) as a whole when viewed in the front-rear direction. That is, two hook-shaped openings are offset from each other in the up-down direction. Alternative to the present embodiment, the two hook-shaped openings may be arranged at the same height in the up-down direction so that the two hook-shaped openings face each other. Specifically, the whole shape of the terminal member 40 may be a downward or upward C-shape when viewed in the front-rear direction.

Another member (a part of the pedestal portion 36 or an end portion of the coil 20 (an end portion in the drawn-out portion 26)) other than the terminal member 40 being arranged while be held by the hook portion in the up-down direction means that the member being arranged between a part on the distal end side and a part on the proximal end side in the terminal member 40 forming a hook shape in the up-down direction. The terminal member 40 may contact the other member or the terminal member 40 (in particular, a part on the distal end side or a part on the proximal end side in the terminal member 40 forming the hook shape) may be separated from the other member.

In the present embodiment, the terminal member 40 is arranged in the pedestal portion 36. Specifically, the first hook portion 42 of the terminal member 40 is hooked on a part of the pedestal portion 36 (a part including the bottom surface of the pedestal portion 36). The protruding end portion of the second hook portion 44 is housed in a terminal housing recess 36k (see FIG. 6A) formed in the pedestal protruding portion 36g. The protruding end portion of the hook portion is the distal end portion of the hook portion in the protruding direction of the hook portion. The terminal housing recess 36k (see FIG. 6A) is a recess that is formed in a side surface of the pedestal protruding portion 36g and is depressed inward in the left-right direction. The protruding end portion of the hook portion is interposed between a pair of wall portions defining the terminal housing recess 36k in the front-rear direction. The terminal housing recess 36k makes it possible to reduce a positional shift of the terminal member 40 in the front-rear direction.

As shown in FIG. 6A, in the present embodiment, a cutout portion 36a is formed in a part of the pedestal portion 36 that is clamped by the first hook portion 42. The cutout portion 36a is formed by recessing the pedestal portion 36 inward in the front-rear direction. Forming the cutout portion 36a makes it possible to house the protruding portion 43 described below in the cutout portion 36a. Forming the cutout portion 36a makes it possible to visually (including image recognition with an apparatus) confirm a joining state between the drawn-out portion 26 and the terminal member 40 by means of solder 70.

As shown in FIG. 6A, the terminal member 40 of the present embodiment includes the protruding portion 43. The protruding portion 43 is a flat plate portion that protrudes outward in the axial direction from a part on the hook-shaped proximal end side of the first hook portion 42. The protruding portion 43 in the present embodiment extends to be slightly inclined with respect to the lateral direction. Specifically, the protruding portion 43 is inclined downward toward the outward side in the axial direction. Therefore, the protruding portion 43 is arranged in the cutout portion 36a. Specifically, the protruding portion 43 is interposed between wall portions forming the cutout portion 36a in the left-right direction. This satisfactorily reduces the positional shift of the terminal member 40 in the left-right direction with respect to the pedestal portion 36. As a result, the terminal member 40 is satisfactorily fixed to the pedestal portion 36.

A protruding dimension (a dimension in the protruding direction, a dimension along a surface of the protruding portion 43) of the protruding portion 43 may be the same as a depth dimension (a dimension in the axial direction) of the cutout portion 36a, may be larger than that, or may be smaller than that.

In FIGS. 6A and 6B, for convenience, an inclination angle of the protruding portion 43 is shown as being largely inclined. In the actual coil component 1, the protruding portion 43 may extend in a direction that has a larger lateral component.

Alternative to the present embodiment, the protruding portion 43 may extend in the axial direction without being inclined. In this case, the protruding portion 43 need not be housed in the cutout portion 36a.

In the present embodiment, as shown in FIG. 4, a pair of two end arrangement recesses 36i (a first end arrangement recess 36i1 and a second end arrangement recess 36i2) are formed in the surface of the pedestal portion 36. The end arrangement recesses 36i are recessed grooves in which the corresponding drawn-out portions 26 are arranged.

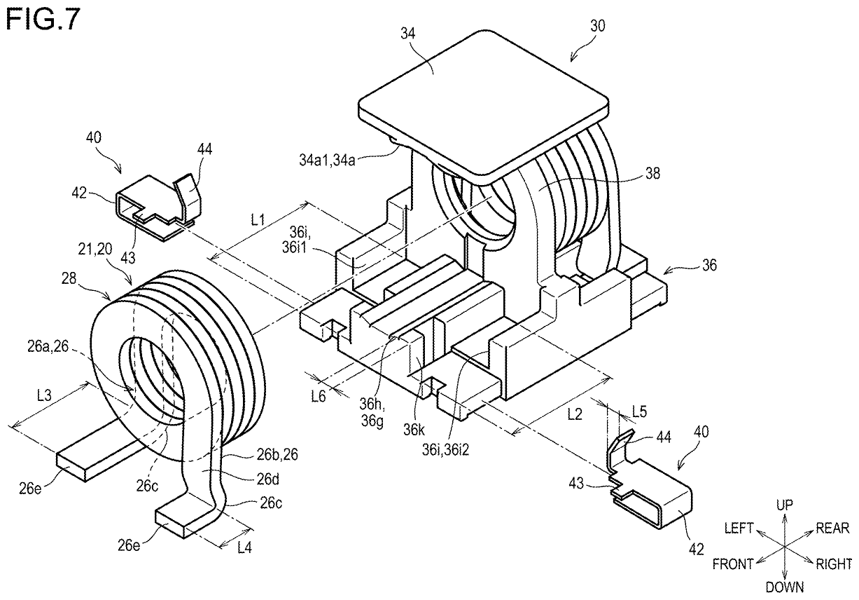

As shown in FIG. 7, respective dimensions (a dimension L1 and a dimension L2) in the axial direction of the pair of end arrangement recesses 36i are larger than any of dimensions (a dimension L3 and a dimension L4) in the axial direction (the front-rear direction) of parts (the distal end portions 26e (see FIG. 3)) arranged in the end arrangement recesses 36i in the respective drawn-out portions (the first drawn-out portion 26a and the second drawn-out portion 26b) at both end portions of the coil 2.

Since the end arrangement recesses 36i have a sufficient length dimension as described above, the coil 20 can be arranged on the pedestal portion 36 regardless of the length of the drawn-out portion 26. Specifically, depending on the spiral direction of the coil 20, there are a case where the dimension in the axial direction of the first drawn-out portion 26a is longer than that of the second drawn-out portion 26b and a case where the dimension in the axial direction of the first drawn-out portion 26a is shorter than that of the second drawn-out portion 26b. Since the pair of end arrangement recesses 36i have the above-described dimensional relationship, the drawn-out portions 26 are arranged in the respective end arrangement recesses 36i regardless of the spiral direction of the coil 20.

The end arrangement recess 36i is a recess formed by recessing the upper surface of the pedestal portion 36 downward, and a portion in which the drawn-out portion 26 is arranged. The bottom portion of the end arrangement recess 36i in the present embodiment is arranged below the elevated portion 36j and the pedestal protruding portion 36g. A part of the end arrangement recess 36i is arranged between the elevated portion 36j and the pedestal protruding portion 36g. The end arrangement recess 36i includes not only a space interposed between the elevated portion 36j and the pedestal protruding portion 36g but also a space on the outward side with respect to the space in the front-rear direction. In other words, in the present embodiment, the end arrangement recess 36i also includes a space in which the terminal member 40 is arranged.

The end arrangement recess 36i in the present embodiment opens outward in the axial direction. That is, at an outer end (one end on an outer side in the front-rear direction) of the end arrangement recess 36i, an internal space of the end arrangement recess 36i communicates with an external space of the coil component 1 (in particular, the base unit 30). The external space of the coil component 1 (in particular, the base unit 30) is a space outside an envelope volume of the coil component 1 (in particular, the base unit 30). In other words, the internal space of the end arrangement recess 36i is defined by a part of the base unit 30 on both sides in the left-right direction and on an inner side in the front-rear direction (on a standing portion 38 side in the front-rear direction), while not being defined by a part of the base unit 30 at an outer end of the end arrangement recess 36i. Accordingly, as described below, the coil can be inserted into the base unit 30 in the axial direction to arrange the drawn-out portion 26 in the end arrangement recess 36i.

In the present embodiment, the bottom portion (a region in which the terminal member 40 is arranged) on the outward side in the end arrangement recess 36i is arranged while being depressed further downward than the bottom portion (a region in which the terminal member 40 is not arranged) on the inward side in the end arrangement recess 36i. Accordingly, when the terminal member 40 is arranged in the bottom portion on the outward side, a height difference between the surface of the terminal member 40 and the bottom portion on the inward side of the end arrangement recess 36i is reduced, which makes it possible to arrange the coil 20 in the end arrangement recess 36i more stably.

In the present embodiment, one end portions (inner end portions) of the first end arrangement recess 36i1 and the second end arrangement recess 36i2 extend to the proximal end portion (a boundary portion between the standing portion 38 and the pedestal portion 36) of the standing portion 38. In other words, inner end portions of the first end arrangement recess 36i1 and the second end arrangement recess 36i2 are in contact with (adjacent to) the standing portion 38. That is, a surface of the standing portion 38 (in particular, a main surface of the standing portion 38) is a wall surface that defines an internal space of the first end arrangement recess 36i1 and the second end arrangement recess 36i2 (in particular, a space at the inner end portions thereof). The other end portions (outer end portions) of the first end arrangement recess 36i1 and the second end arrangement recess 36i2 extend to the end portion on the outward side of the pedestal portion 36 in the front-rear direction.

The first end arrangement recess 36i1 and the second end arrangement recess 36i2 are arranged to be separated in the left-right direction, and are arranged along each other. That is, the extending direction of the first end arrangement recess 36i1 and the extending direction of the second end arrangement recess 36i2 are substantially parallel to each other. Each of the extending direction of the first end arrangement recess 36i1 and the extending direction of the second end arrangement recess 36i2 is the axial direction (the front-rear direction, or the depth direction in the paper surface).

In the present embodiment, the dimensions (the dimension L1 and the dimension L2) of the end arrangement recesses 36i in the axial direction are a length from the proximal end portion (the boundary portion between the standing portion 38 and the pedestal portion 36) of the standing portion 38 to the outer end portion of the pedestal portion 36. In the present embodiment, the dimension (the dimension L1) of the first end arrangement recess 36i1 in the axial direction has the same length as the dimension (the dimension L2) of the second end arrangement recess 36i2 in the axial direction. Alternative to the present embodiment, the dimension (the dimension L1) of the first end arrangement recess 36i1 in the axial direction may be larger or smaller than the dimension (the dimension L2) of the second end arrangement recess 36i2 in the axial direction.

A part of the drawn-out portion 26 which is arranged in the end arrangement recess 36i is a part of the drawn-out portion 26 which is arranged along the bottom portion of the end arrangement recess 36i. That is, the end arrangement recess 36i in the present embodiment is the distal end portion 26e (see FIG. 3).

As shown in FIG. 4, in the present embodiment, the core 10 is fixed to the top plate portion 34 with an adhesive 50. More specifically, the upper surface (the bottom surface of the top plate arrangement recess 18) of the core 10 and the lower surface 34b of the top plate portion 34 are separated from each other in the up-down direction. The adhesive 50 is arranged between the upper surface of the core 10 and the lower surface 34b of the top plate portion 34 in the up-down direction, and is fixed to each of the upper surface of the core 10 and the lower surface of the top plate portion 34.

The core 10 is bonded to the top plate portion 34 with the adhesive 50 in this manner, so that the core 10 is satisfactorily fixed to the base unit 30. Since the adhesive 50 is arranged between the core 10 and the top plate portion 34, it is possible to reduce the wear of the core 10 or the top plate portion 34 due to rubbing of the core 10 against the top plate portion 34 during the transfer of the coil component 1 (including an electronic apparatus and a product on which the coil component 1 is mounted).

A resin such as an epoxy resin is exemplified as the adhesive.

In the present embodiment, the adhesive 50 is dropped on each of four corners of the top plate portion 34.

As shown in FIG. 1, the coil component 1 in the present embodiment further includes a tape portion 60.

The tape portion 60 is arranged fully around the periphery of the first core 11 and the second core 12. The state in which the first core 11 and the second core 12 are adjacent to each other or contact each other is maintained by the tape portion 60.

As shown in FIG. 4, in the present embodiment, the drawn-out portion 26 is brazed to the terminal member 40 with a brazing material (by solder 70). Accordingly, the drawn-out portion 26 is electrically connected to the terminal member 40.

In the present embodiment, the solder 70 covers the upper portion of the second hook portion 44 in the terminal member 40. In the present embodiment, a part on the distal end side of the second hook portion 44 and the drawn-out portion 26 are separated from each other in the up-down direction, and a part of the solder 70 is arranged between a part on the distal end side of the second hook portion 44 and the drawn-out portion 26.

A method of connecting the terminal member 40 and the drawn-out portion 26 is not limited to the above-described method. The terminal member 40 and the drawn-out portion 26 may be simply in contact with each other to be electrically connected to each other.

### (Method of Manufacturing Coil Component)

Hereinafter, a method of manufacturing the coil component 1 of the present embodiment (hereinafter, sometimes referred to as this method) will be described.

FIG. 7 is a perspective view of the coil component 1 in the manufacturing process to describe this method.

First, an overview of this method will be described.

This method includes a coil attachment step. This method in the present embodiment further includes a position step of a terminal member, and a coil arrangement step, and a crimp step. Each step will be described below in detail.

Next, the detail of this method will be described.

The terminal member 40 is formed by folding a flat plate portion extending in a longitudinal direction. The terminal member 40 includes a hook portion (a first hook portion 42) having a hook shape at one end portion. That is, the flat plate portion is folded so that one end portion in the longitudinal direction has a hook shape to form the first hook portion 42.

As shown in FIG. 7, in the present embodiment, the first hook portion 42 of the terminal member 40 before being arranged to the base unit 30 is formed so that hook-shaped proximal end portion and distal end portion are arranged substantially parallel to each other, but the second hook portion 44 is formed so that the hook-shaped proximal end portion is arranged obliquely with respect to the distal end portion. That is, the second hook portion 44 has a hook shape that opens more largely than the first hook portion 42.

A dimension (a dimension L5) of the hook-shaped distal end portion of the second hook portion 44 in the width direction (the left-right direction) is preferably smaller than a dimension (a depth dimension, or a dimension L6) of the terminal housing recess 36k in the width direction. Accordingly, in the coil attachment step described below, the second hook portion 44 is prevented from interfering with the coil 20.

In the terminal member arrangement step, the first hook portion 42 is arranged so that the pedestal portion 36 is interposed by the first hook portion 42 in the standing portion (the up-down direction). Specifically, a part of the pedestal portion 36 is arranged between the hook-shaped distal end portion and proximal end portion of the first hook portion 42.

In the present embodiment, the terminal member 40 is inserted into the base unit 30 toward the inner side in the left-right direction in a state in which an opening of the first hook portion 42 in the terminal member 40 faces the pedestal portion 36. At this time, the second hook portion 44 (in particular, the hook-shaped distal end portion of the second hook portion 44) is housed in the terminal housing recess 36k.

The above-described terminal member arrangement step is preferably performed before the coil attachment step, but the present invention is not limited thereto. The terminal member arrangement step may be performed after the coil attachment step.

In the terminal member arrangement step, the protruding portion 43 preferably extends in the axial direction. That is, it is preferable that the protruding portion 43 is not inclined as shown in FIG. 6A. This is because the protruding portion 43 does not interfere with the pedestal portion 36 when the terminal member 40 is arranged. After the terminal member 40 is arranged, the protruding portion 43 may be pressed downward so that the protruding portion 43 is inclined and extends with respect to the axial direction.

In the coil attachment step, the coil 20 is attached to the base unit 30. This attachment is performed by moving the coil 20 along the axial direction of the coil 20 as follows. Specifically, the coil 20 is moved in a direction in which one end surface (an inner end surface 21a, 22a) of the coil 20 faces the facing surface 38a which is a side surface of the standing portion 38. The coil 20 is moved toward the facing surface 38a. That is, the coil 20 is inserted into the base unit 30 toward the standing portion 38 along the axial direction.

When the coil 20 is attached to the base unit 30 as described above, the coil 20 can be positioned by the standing portion 38. This is because even when the coil 20 is inserted into the base unit 30 accidentally deeply, the inner end surface 21a, 22a of the coil 20 contacts the facing surface 38a of the standing portion 38 so that the insertion of the coil 20 can be stopped.

Here, the coil 20 being inserted into the base unit 30 means that the coil 20 is moved in a predetermined direction to arrange the coil 20 in a predetermined space of the base unit 30. The periphery of the predetermined space need not be necessarily covered with the base unit 30. That is, in the present embodiment, the coil 20 is inserted into the space defined by the standing portion 38, the top plate portion 34, and the pedestal portion 36, but the present invention is not limited thereto. For example, even when the base unit 30 does not include the top plate portion 34, the coil 20 being arranged in the space defined by the pedestal portion 36 and the standing portion 38 in the base unit 30 is represented as the coil 20 being inserted into the base unit 30.

Similarly, the core 10 (see FIG. 1) being inserted into the base unit 30 means that the core 10 is moved in a predetermined direction to arrange the core 10 in a predetermined space of the base unit 30.

In the coil attachment step, the winding portion 28 is guided by the protruding end surface 34a1 of the top plate protruding portion 34a and the protruding end surface 36h of the pedestal protruding portion 36g to be inserted into the base unit 30. After the insertion, the winding portion 28 is arranged between the protruding end surface 34a1 of the top plate protruding portion 34a and the protruding end surface 36h of the pedestal protruding portion 36g.

In the coil attachment step, the two drawn-out portions 26a and 26b are inserted into the two end arrangement recesses 36i1 and 36i2 in the axial direction, respectively. Specifically, the coil 20 is attached such that the end portion of the coil 20 is arranged on a part of the terminal member 40. In the present embodiment, a part of the terminal member 40 at which the end portion of the coil 20 is arranged is the hook-shaped proximal end portion of the second hook portion 44.

In the crimp step, the end portion (in particular, the distal end portion 26e in the drawn-out portion 26) of the coil 20 is crimped by the hook-shaped distal end portion in the second hook portion 44 and the hook-shaped proximal end portion in the second hook portion 44. Specifically, the hook-shaped distal end portion and proximal end portion of the second hook portion 44 are brought closer to each other by pressing the hook-shaped distal end portion in the second hook portion 44 downward. Here, the crimping means that the hook-shaped distal end portion in the second hook portion 44 press-contacts the end portion of the coil 20. After the crimp step, the hook-shaped distal end portion in the second hook portion 44 may press-contact the end portion of the coil 20, may simply contact the end portion, or may be separated from the end portion. The crimp step is performed after the coil attachment step.

The above-described second hook portion 44 is formed by the crimp step.

The coil 20 can be fixed to the pedestal portion 36 using the terminal member 40 by the above-described crimp step.

The present invention is not limited to the embodiments described above and includes forms such as various modifications and improvements as long as the object of the present invention is achieved.

The following modified examples may be appropriately combined.

Alternative to the present embodiment, the base unit 30 need not include the top plate portion 34. For example, the base unit 30 may terminate at the upper end portion of the standing portion 38.

The embodiments described above include the following technical ideas.

(1) A coil component including:
a plurality of (two or more) cores;
a plurality of (two or more) coils that are spirally arranged around at least respective parts of the plurality of cores; and
a base unit that holds the coils and the cores and has a terminal member arranged thereon, in which
the base unit includes
   a pedestal portion on which the terminal member is arranged and the coils or the cores are placed, and a standing portion that is arranged standing in a standing direction to intersect a surface of the pedestal portion,
   in which the pedestal portion and the standing portion are integrally formed, and
one end surface of each of the plurality of coils faces a facing surface which is a side surface of the standing portion.

(2) The coil component described in (1), in which
the one end surface of a first coil of the coils faces the one end surface of a second coil of the coils in an axial direction of the first coil, and
the base unit is provided with
a locking portion arranged between a first core of the cores and a second core of the cores in the axial direction.

(2-1) The coil component, in which
the core includes a housing recess formed by causing one end portion on an inward side of the base unit in the axial direction to be depressed outward with respect to the base unit in the axial direction, and
the locking portion is arranged in the housing recess.

(2-2) The coil component, in which
a surface of the core includes an abutment surface that defines the housing recess and faces a surface of the locking portion in the axial direction, and
each of an abutment surface of the first core and an abutment surface of the second core is separated from the locking portion in the axial direction.

(2-3) The coil component, in which
a separation distance between the abutment surface of the first core and the locking portion in the axial direction is larger than a separation distance between the abutment surface of the second core and the locking portion in the axial direction.

(2-4) The coil component, in which
a surface of the core includes an abutment surface that defines the housing recess and faces a surface of the locking portion in the axial direction,
the abutment surface of the first core is separated from the locking portion in the axial direction, and
the abutment surface of the second core contacts the locking portion.

(3) The coil component described in (1) or (2), in which
the core covers
   a peripheral surface of the coil,
the base unit further includes
   a top plate portion that is arranged to interpose the standing portion between the top plate portion and the pedestal portion in the standing direction, and
the top plate portion
   is formed integrally with the standing portion, and
   covers at least a part of the core when viewed from a top plate portion side in the standing direction.

(4) The coil component described in (3), in which
a first recessed groove extending in the standing direction is formed in the facing surface of the standing portion, and
the first recessed groove extends between an inside of a region facing the one end surface in the facing surface and a peripheral edge of the region.

(5) The coil component described in (4), in which
a second recessed groove extending in an axial direction of the coil is formed in a lower surface facing a pedestal portion side in the standing direction in the top plate portion, and
one end portion of the second recessed groove
   communicates with one end portion of the first recessed groove.

(6) The coil component described in (4) or (5), in which
a third recessed groove extending in an axial direction of the coil is formed in an upper surface facing the top plate portion in the standing direction in the pedestal portion, and
one end portion of the third recessed groove
   communicates with one end portion of the first recessed groove.

(6-1) The coil component, in which
the coil is exposed from the core when viewed from an outward side in the axial direction.

(7) The coil component described in any one of (3) to (6), in which
the core
   includes a sidewall portion that surrounds a part of a peripheral surface of the coil, and
   includes a hollow portion that is defined by the sidewall portion and in which the coil is housed, and
the hollow portion is exposed from the top plate portion when viewed from the top plate portion side in the standing direction.

(7-1) The coil component, in which
a part on the outward side of the hollow portion in the axial direction is exposed from the top plate portion.

(8) The coil component described in any one of (3) to (7), in which
a protruding portion in which a protruding end surface extends in the axial direction of the coil along a part of a peripheral surface of the coil is formed in each of the top plate portion and the pedestal portion.

(8-1) The coil component, in which
the protruding end surface includes a recessed groove that is depressed in a direction opposite to a protruding direction of the protruding portion, and
a bottom surface of the recessed groove is arranged above an end portion of the protruding end surface in a width direction of the base unit.

(9) The coil component described in any one of (3) to (8), in which
in a part on the top plate portion side of the core,
   a top plate arrangement recess is formed which is a recess that is depressed toward the pedestal portion side in the standing direction,
the top plate arrangement recess extends in the axial direction of the coil, and
at least a part of the top plate portion is arranged inside the top plate arrangement recess.

(9-1) The coil component, in which
a lower portion of the top plate portion is arranged in the top plate arrangement recess, and an upper portion of the top plate portion is arranged in a space above the top plate arrangement recess which is an exterior space of the top plate arrangement recess.

(10) The coil component described in any one of (1) to (9), in which
the terminal member includes two hook portions including a first hook portion and a second hook portion each having a hook shape,
a protruding direction of the hook shape in the first hook portion is a direction opposite to the protruding direction of the hook shape in the second hook portion,
a part of the pedestal portion is arranged while being held by the first hook portion, and
an end portion of the coil is arranged while being held by the second hook portion in the standing direction.

(10-1) The coil component, in which
a pedestal protruding portion has a terminal housing recess that is formed in a side surface of the pedestal protruding portion and is a recess depressed toward an inner side in the width direction of the base unit, and
a protruding end portion of the hook portion is arranged in the terminal housing recess and is arranged between a pair of wall portions defining the terminal housing recess in the axial direction.

(11) The coil component described in any one of (1) to (10), in which
the coil includes drawn-out portions that extend downward from respective end portions of the coil, are folded and extend in the axial direction of the coil along a surface of the pedestal portion,
a pair of end arrangement recesses which are recessed grooves in which each of the drawn-out portions are formed are formed in the surface of the pedestal portion, and
a dimension in the axial direction of each of the pair of the end arrangement recesses is larger than any of dimensions in the axial direction of parts arranged in the end arrangement recesses in the drawn-out portions at the both end portions.

(11-1) The coil component, in which
each of the pair of end arrangement recesses extends to a proximal end of the standing portion in the pedestal portion.

(12) A method of manufacturing a coil component that includes:
a plurality of (two or more) cores;
a plurality of (two or more) coils that are spirally arranged around at least respective parts of the cores; and
a base unit that holds the coils and the cores and has a terminal member arranged thereon, in which
the base unit
   includes a pedestal portion on which the terminal member is arranged and the coils or the cores are placed, and a standing portion that is arranged standing in a standing direction to intersect a surface of the pedestal portion, wherein
   the pedestal portion and the standing portion are integrally formed, the method comprising:
attaching the coil to the base unit by moving the coil toward a facing surface which is a side surface of the standing portion in such a direction that one end surface of the coil faces the facing surface.

(13) The method of manufacturing a coil component described in (12), in which
the terminal member
   is formed by folding a flat plate portion extending in a longitudinal direction, and
   includes a hook portion at one end portion,
in attaching the coil, the coil is attached such that an end portion of the coil is arranged on a part of the terminal member, the method further including:
arranging a terminal member to arrange the hook portion to interpose the pedestal portion by the hook portion in the standing direction; and
crimping the end portion of the coil by another end portion and the part of the terminal member after attaching the coil.

(14) A coil component, further including
an adhesive, in which
an upper surface of a core and a lower surface of a top plate portion are separated from each other in an up-down direction, and
the adhesive is arranged between the upper surface of the core and the lower surface of the top plate portion in a standing direction, and
is fixed to each of the upper surface of the core and the lower surface of the top plate portion.

What is claim is:

1. A coil component, comprising:
a plurality of cores;
a plurality of coils that are spirally arranged around at least respective parts of the plurality of cores; and
a base unit that holds the coils and the cores and has a terminal member arranged on the base unit, wherein
the base unit includes
a pedestal portion on which the terminal member is arranged and the coils or the cores are placed, and a standing portion that is arranged standing in a standing direction to intersect a surface of the pedestal portion,
wherein the pedestal portion and the standing portion are integrally formed, and
one end surface of each of the plurality of coils faces a facing surface which is a side surface of the standing portion.

2. The coil component according to claim 1, wherein
the one end surface of a first coil of the coils faces the one end surface of a second coil of the coils in an axial direction of the first coil, and
the base unit is provided with
a locking portion arranged between a first core of the cores and a second core of the cores in the axial direction.

3. The coil component according to claim 1, wherein
the core covers
a peripheral surface of the coil,
the base unit further includes
a top plate portion that is arranged to interpose the standing portion between the top plate portion and the pedestal portion in the standing direction, and
the top plate portion
is formed integrally with the standing portion, and
covers at least a part of the core when viewed from a top plate portion side in the standing direction.

4. The coil component according to claim 3, wherein
a first recessed groove extending in the standing direction is formed in the facing surface of the standing portion, and
the first recessed groove extends between an inside of a region facing the one end surface in the facing surface and a peripheral edge of the region.

5. The coil component according to claim 4, wherein
a second recessed groove extending in an axial direction of the coil is formed in a lower surface facing a pedestal portion side in the standing direction in the top plate portion, and
one end portion of the second recessed groove
communicates with one end portion of the first recessed groove.

6. The coil component according to claim 4, wherein
a third recessed groove extending in an axial direction of the coil is formed in an upper surface facing the top plate portion side in the standing direction in the pedestal portion, and
one end portion of the third recessed groove
communicates with one end portion of the first recessed groove.

7. The coil component according to claim 3, wherein
the core
includes a sidewall portion that surrounds a part of a peripheral surface of the coil, and
includes a hollow portion that is defined by the sidewall portion and in which the coil is housed, and
the hollow portion is exposed from the top plate portion when viewed from the top plate portion side in the standing direction.

8. The coil component according to claim 3, wherein
a protruding portion in which a protruding end surface extends in the axial direction of the coil along a part of a peripheral surface of the coil is formed in each of the top plate portion and the pedestal portion.

9. The coil component according to claim 3, wherein
in a part on the top plate portion side of the core,
a top plate arrangement recess is formed which is a recess that is depressed toward the pedestal portion side in the standing direction,
the top plate arrangement recess extends in the axial direction of the coil, and
at least a part of the top plate portion is arranged inside the top plate arrangement recess.

10. The coil component according to claim 1, wherein
the terminal member includes two hook portions including a first hook portion and a second hook portion each having a hook shape,
a protruding direction of the hook shape in the first hook portion is a direction opposite to the protruding direction of the hook shape in the second hook portion,
a part of the pedestal portion is arranged while be held by the first hook portion, and
an end portion of the coil is arranged while be held by the second hook portion in the standing direction.

11. The coil component according to claim 1, wherein
the coil includes drawn-out portions that extend downward from respective end portions of the coil, are folded and extend in the axial direction of the coil along a surface of the pedestal portion,
a pair of end arrangement recesses which are recessed grooves in which each of the drawn-out portions are arranged are formed in the surface of the pedestal portion, and
a dimension in the axial direction of each of the pair of the end arrangement recesses is larger than any of dimensions in the axial direction of parts arranged in the end arrangement recesses in the drawn-out portions at the both end portions.

12. A method of manufacturing a coil component that comprises:
a plurality of cores;
a plurality of coils that are spirally arranged around at least respective parts of the cores; and
a base unit that holds the coils and the cores and has a terminal member arranged on the base unit, wherein
the base unit
includes a pedestal portion on which the terminal member is arranged and the coils or the cores are placed, and a standing portion that is arranged standing in a standing direction to intersect a surface of the pedestal portion, wherein
the pedestal portion and the standing portion are integrally formed, the method comprising:
attaching the coil to the base unit by moving the coil toward a facing surface which is a side surface of the standing portion in such a direction that one end surface of the coil faces the facing surface.

13. The method of manufacturing a coil component according to claim 12, wherein
the terminal member
is formed by folding a flat plate portion extending in a longitudinal direction, and
includes a hook portion at one end portion,
in attaching the coil, the coil is attached such that an end portion of the coil is arranged on a part of the terminal member, the method further including:
arranging a terminal member to arrange the hook portion to interpose the pedestal portion by the hook portion in the standing direction; and
crimping the end portion of the coil by another end portion and the part of the terminal member after attaching the coil.
